(19) United States
(12) Patent Application Publication
(10) Pub. No.: US 2012/0222051 A1
(43) Pub. Date: Aug. 30, 2012

(54) SHARED RESOURCE ACCESS VERIFICATION

(75) Inventors: Laxmi Narsimha Rao Kakulamarri, Redmond, WA (US); Subba Raju V. Thikkireddy, Bellevue, WA (US)

(73) Assignee: MICROSOFT CORPORATION, Redmond, WA (US)

(21) Appl. No.: 13/035,765

(22) Filed: Feb. 25, 2011

(51) Int. Cl. G06F 9/46

(52) U.S. Cl. 719/328

(57) ABSTRACT

Shared resource access verification techniques are described. In one or more implementations, one or more hooks are applied to one or more application programming interfaces (APIs), by a computing device, that involve access of threads in a single process to one or more shared resources. Information is stored, by the computing device, that describes the access and identifies respective threads that were involved in the access.

### BACKGROUND

Applications may use a variety of different resources to perform functions intended by the applications. For example, execution of an application may involve a plurality of different threads that are executed on one or more processers of a computing device. However, two or more of these threads (e.g., threads within a single process of the application) may desire access to the same resource, such as data stored within memory.

Although techniques were developed to manage this access, these techniques may fail in certain instances such as due to incorrect usage by an application. This failure may be further complicated by a difficulty and even inability of these traditional techniques to determine how the failure occurred, thereby also making it difficult to solve the problem.

### SUMMARY

Shared resource access verification techniques are described. In one or more implementations, one or more hooks are applied to one or more application programming interfaces (APIs), by a computing device, that involve access of threads in a single process to one or more shared resources. Information is stored, by the computing device, that describes the access and identifies respective threads that were involved in the access.

In one or more implementations, information involved in API communication is intercepted that pertains to locks used to manage access to a resource by threads in a process that are executed by a computing device. Verification is performed of the captured information to determine whether the access to the resource by the threads would result in an error. Responsive to a determination as part of the verification that the error would result, the captured information is reported which includes an identification of ownership of a respective lock.

In one or more implementations, a call is intercepted via a hook to an API of a reader/writer module, executed by a computing device, that is configured to manage access of threads in a single process to one or more shared resources of the computing device. Information is captured that is related to the call and that describes an address of a lock of the reader/writer module involved and current ownership of the lock. The call is forwarded to the API responsive to a verification that the call would not result in an error and the captured information is reported responsive to a verification that the call would result in an error;

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform shared resource verification techniques.

FIG. 2 is an illustration of a system in an example implementation showing an application verifier of FIG. 1 as being employed to collect information that may be used for diagnosis.

FIG. 3 is a flow diagram depicting a procedure in an example implementation in which information is stored that identifies ownership of a lock used to manage access to a resource by threads in a process that are executed by a computing device.

FIG. 4 is a flow diagram depicting a procedure in an example implementation in which verification techniques are employed on data that pertains to locks used to manage access to a resource by threads in a process.

### DETAILED DESCRIPTION

Overview

Threads of applications may access a variety of different resources to perform functionality of the application. In order to share access to a resource between these threads, techniques were developed to manage this access. However, optimizations of techniques that were traditionally employed to manage this access did not support diagnostic techniques that may be employed to manage errors and other situations that may be encountered during execution.

Shared resource access verification techniques are described. In one or more implementations, techniques are employed that may be used to collect information regarding actions performed by threads of an application. For example, these techniques may be employed to collect information regarding access by threads in a single process to a reader/writer module. An application verifier, for instance, may hook one or more application programming interfaces of the reader/writer module that involve shared resource access. Data describing this interaction, including information describing “ownership,” may then be stored and leveraged to diagnose incorrect usage of locks of the reader/writer module by the threads. This ownership information may then be leveraged to correct this usage, such as by a debugger module of the application, a reporting service, and so on. Further discussion of these techniques may be found in relation to the following sections.

In the following discussion, an example environment is first described that may be leveraged to provide shared resource verification techniques. Example verifications and APIs are then described which may be employed in the environment. Example procedures are then described which may also be employed in the example environment as well as other environments. Accordingly, performance of the example procedures is not limited to the example environment and the example environment is not limited to performing the example procedures.

### Example Environment

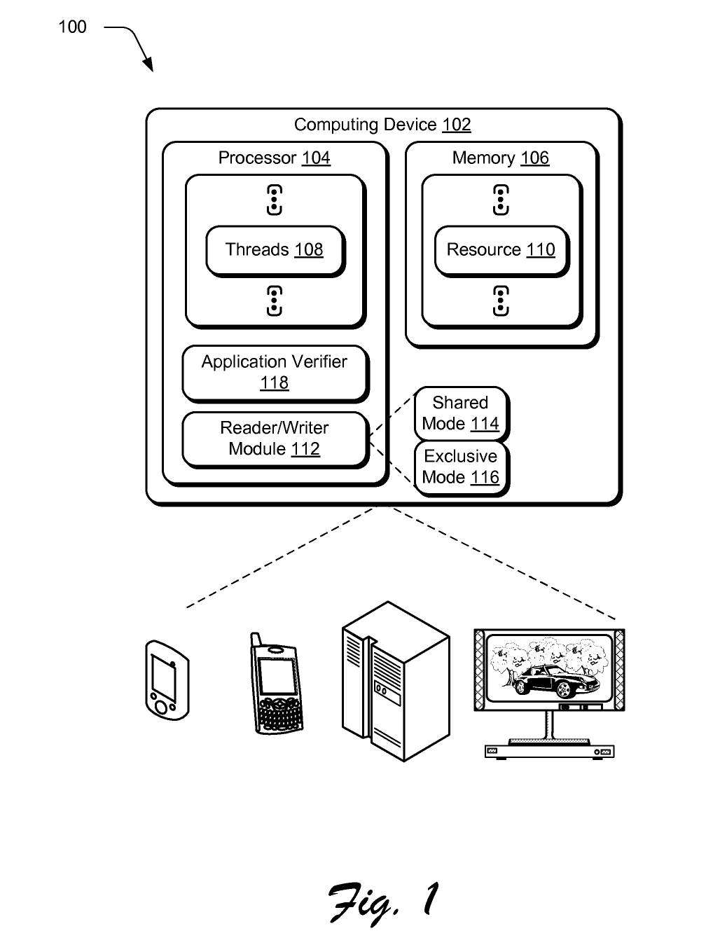

FIG. 1 is an illustration of an environment 100 in an example implementation that is operable to employ techniques described herein. The illustrated environment 100 includes a computing device 102, which may be configured in a variety of ways as illustrated. For example, the computing device 102 may be configured as a computer that is capable of communicating over a network 104, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations, a remote control and set-top box combination, and so on.

The computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

The computing device 102 is also illustrated as including a processor 104 and memory 106. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single processor 104 and memory 106 are shown, a wide variety of types and combinations of memory and/or processors may be employed.

The computing device 102 is illustrated as executing one or more threads 108 that when executed by the processor 104 may request access to one or more resources 110. For example, a plurality of threads 108 may be associated with a single process. Threads 108 are generally scheduled by an operating system or other entity, such as in parallel, use time-division multiplexing, and so on.

In some instances, execution of two or more of the threads may involve a single resource 110 and thus the threads 108 may “share” the resource 110. To manage this sharing, a reader/writer module 112 may use different modes in which threads 108 may access a shared resource 110 through use of one or more locks. For example, the reader/writer module 112 may support a shared mode 114 that grants read-only access to multiple threads 108, which enables the thread 108 to read data from the shared resource 110 concurrently and “locks out” an ability to write to the shared resource 110. The reader/writer module 112 may also support an exclusive mode 116 that grants read/write access to a single thread 108 at a time, such as to perform a write, but “locks out” other threads from access the resource 110. Thus, when a lock is acquired in the exclusive mode 116, other threads are not permitted to access the shared resource 110 until the writing thread releases the lock in an implementation.

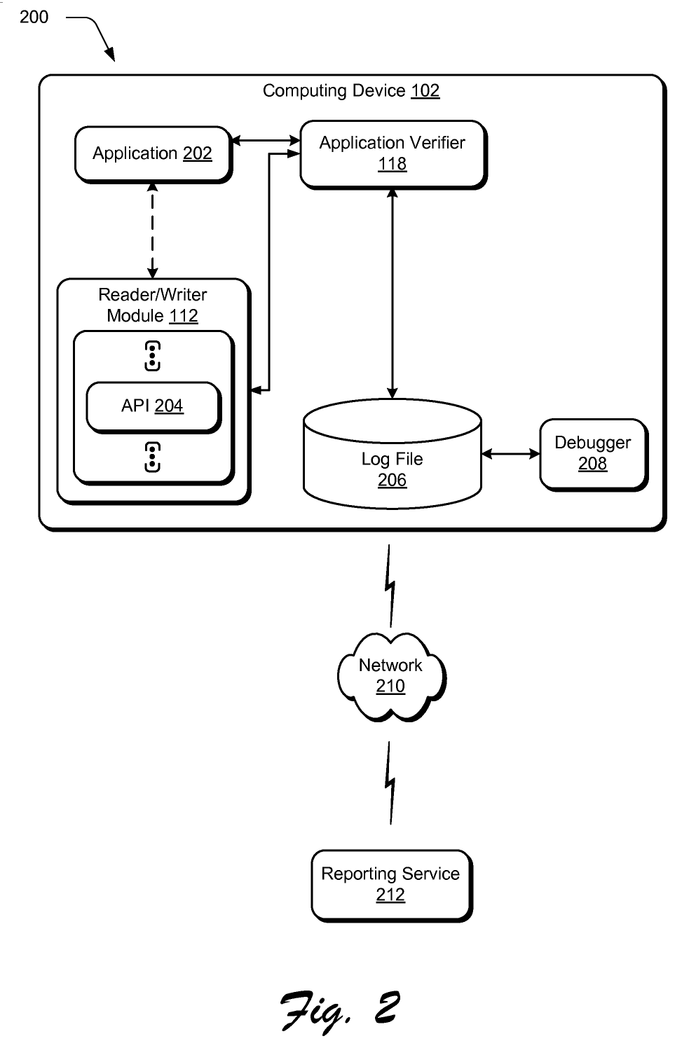

However, since these locks were traditionally optimized for speed and memory, information was not maintained about these locks by the reader-writer module 112, e.g., the locks may approximate the size of a pointer and traditionally do not contain ownership information. Incorrect usage of these locks of the reader/writer module 112 by the threads 108 may lead to memory corruptions, unresponsive or un-deterministic behavior by an application that employs the threads 108, and so on. Accordingly, the computing device 102 may employ an application verifier 118 to validate usage of locks by the reader/writer module 112 and threads 108 that request this access, such as to track ownership information along with stack traces. In this way, the application verifier 118 may be leveraged to diagnose issues that may arise from the incorrect and even correct use of locks by the reader/writer module 112, further discussion of which may be found in relation to FIG. 2.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

FIG. 2 is an illustration of a system 200 in an example implementation showing the application verifier 118 as being employed to collect information that may be used for diagnosis. The computing device 102 is illustrated as including an application 202 and a reader/writer module 112 having one or more application programming interfaces 204.

The application verifier 118 in the illustrated example is utilized to “hook” one or more of the APIs 204 that involve access to a shared resource 110 of FIG. 1. A variety of different calls may be made to the APIs 204, including calls that may involve shared or exclusive access modes 114, 116 by the reader/writer module 112. Hooking is illustrated in FIG. 2 using a dashed line between the application 202 and the reader/writer module 112 to indicate that although the application 202 intended to call the API of the reader/writer module 112 this call is intercepted first by the application verifier 118, which may then forward the call to the API 204 if warranted, e.g., the data has been verified as further described below.

Information describing this interaction may then be generated by the application verifier 118, e.g., as a log file 206. For example, the log file 206 may gather information that identifies ownership of actions (e.g., calls to APIs 204) by the threads of a single process that called the reader/writer module 112. This information may then be provided to a debugger 208 associated with the application 202 and/or communicated via a network 210 to a reporting service 212.

The information generated by the application verifier 118 may be maintained in a variety of ways. For example, one of more AVL trees may be maintained by the application verifier 118 for the locks of the reader/writer module 112 and “owners” of the locks, e.g., which threads 108 were involved in the lock. For instance, a node for a lock may be created and inserted into the tree when the hook for an “Initialize SRWLock” or “AcquireSRWLockShared/AcquireSRWLockExclusive” APIs are called in case of static initialization of the lock. These nodes may then be deleted when memory 106 corresponding to the locks is freed, a DLL containing the lock is unloaded, and so on. In an implementation, if a DLL containing the global lock is not unloaded or stack space/registers are used for the lock, the corresponding memory 106 maintained by application verifier 118 for this lock is not released. In an implementation, an AVL tree is maintained for the owners of each lock and a node for the owner is created when the lock is acquired and is deleted when the SRW lock is released.

The following structure “AVRF_SRWLOCKS” represents an example AVL tree for locks of the reader/writer module 112:

```
typedef struct _AVRF_AVL_TREE {
  RTL_AVL_TABLE List; // represents the list.
  SRWLOCK Lock; // used to protect accesses to the list.
} AVRF_AVL_TREE, *PAVRF_AVL_TREE;
typedef struct _AVRF_SRWLOCKS {
  BOOL SrwLocksInitialized; // Set to TRUE on initialization.
  PVOID LookAside; // memory used for storing data for locks.
  AVRF_AVL_TREE SRWLocks; // locks tree.
} AVRF_SRWLOCKS, *PAVRF_SRWLOCKS;
```

The following structure AVRF_SRWLOCK_NODE represents lock nodes in a SRWLocks.List. This may be created and inserted in to the tree when “InitializeSRWLock” is called or AcquireSRWLockShared/AcquireSRWLockExclusive are called in case of static initialization of the lock.

```
typedef struct _AVRF_SRWLOCK_NODE {
  PSRWLOCK SRWLock; // Pointer to the actual SRW lock.
  HANDLE InitializeThread; // Id of the thread that initialized.
  PVOID InitStackTrace; // Initialization stack trace.
  AVRF_AVL_TREE Owners; // List of owners for this lock.
} AVRF_SRWLOCK_NODE, *PAVRF_SRWLOCK_NODE;
```

The following data structure may be used to track ownership information of a lock.

```
typedef enum {
  AVRF_SRWLOCK_MODE_SHARED = 0,
  AVRF_SRWLOCK_MODE_EXCLUSIVE
} AVRF_SRWLOCK_MODE;
typedef struct _AVRF_SRWLOCK_OWNER_NODE {
  HANDLE ThreadId; // Id of the thread that acquired the lock.
  AVRF_SRWLOCK_MODE Mode; // Mode the lock was acquired in.
  PVOID AcquireStackTrace; // Acquire stack trace.
} AVRF_SRWLOCK_OWNER_NODE,
*PAVRF_SRWLOCK_OWNER_NODE;
```

Verification Operations

The application verifier 118 may perform a variety of different verification operations to determine whether data communicated via a hooked API 204 will cause an error. Examples of these are referred to in the following discussion as “verifier stops,” even though verification operations performed by the application verifier 118 and operation of the reader-writer module 112, threads 108, and so on may continue.

AVRF_STOP_SRWLOCK_NOT_INITIALIZED

This verifier stop may be shown when a lock is used without initialization. In one or more implementations, InitializeSRWLock is not called to initialize the lock, but rather it is statically initialized by setting it to 0. This stop may be shown on a first acquire or a release of the lock when the lock is not initialized to 0.
Message: The SRW lock is being acquired/released without initialization.
Param1: Pointer to the SRW lock
Param2: NULL
Param3: NULL
Param4: NULL

AVRF_STOP_SRWLOCK_ALREADY_INITIALIZED

This verifier stop may be shown when the lock is being re-initialized.
Message: The lock is being re-initialized.
Param1: Pointer to the lock
Param2: ThreadId of the thread that initialized the lock
Param3: Pointer to the stack trace of the first initialization
Param4: NULL
   If the lock is being actively used by other threads, re-initializing the lock may result in unpredictable behavior by the application including hangs and crashes.

AVRF_STOP_SRWLOCK_MISMATCHED_ACQUIRE_RELEASE

This verifier stop may be shown if the reader/writer module 112 acquire and release calls are mismatched. For example, if the lock was acquired for exclusive access and it is now being released for shared access.
Message: Mismatched Acquire/Release on the lock.
Param1: Pointer to the lock
Param2: ThreadId of the thread that did the Acquire
Param3: Pointer to the stack trace of the Acquire
Param4: NULL

This verifier stop may be involved if a lock was acquired for shared access and is being released using an exclusive release API or a lock was acquired for exclusive access and is being release using the shared release API. This may result in unpredictable behavior by the application including hangs and crashes.

AVRF_STOP_SRWLOCK_RECURSIVE_ACQUIRE

This verifier stop is shown when the lock is being acquired recursively by the same thread.
Message: The lock is being acquired recursively by the same thread.
Param1: Pointer to the lock
Param2: Pointer to the stack trace of the first acquire
Param3: NULL
Param4: NULL
   A lock being acquired recursively by the same thread may result in a deadlock and the thread may block indefinitely.

AVRF_STOP_SRWLOCK_EXIT_THREAD_OWNS_LOCK

This verifier stop may be shown when a thread that is exiting or being terminated owns a reader/writer module 112 lock.
Message: The thread that is exiting or being terminated owns an active lock
Param1: Pointer to lock
Param2: ThreadId of the thread that acquired the lock
Param3: Pointer to the stack trace of the acquire
Param4: NULL
   Exiting or termination of a thread that owns a lock may result in an orphaned lock and the threads trying to acquire this lock may block indefinitely.

AVRF_STOP_SRWLOCK_INVALID_OWNER

This verifier stop may be shown when a thread tries to release a lock that was not acquired by the thread.
Message: The lock being released was not acquired by this thread.
Param1: Pointer to lock
Param2: Current thread Id
Param3: ThreadId of the thread that acquired the lock
Param4: Pointer to the stack trace of the acquire
   As above, this stop is generated if the lock is being released by the thread that did not acquire the lock and is a counter against bad programming practice that may lead to unpredictable behavior by the application.

AVRF_STOP_SRWLOCK_LOCK_IN_FREED_MEMORY

This verifier stop is shown if there is an active lock in the memory being freed.
Message: The memory being freed contains an active lock.
Param1: Pointer to lock
Param2: Memory address being freed
Param3: ThreadId of the thread at acquired the lock
Param4: Pointer to the stack trace of the acquire
   This stop, for instance, may be generated if the memory address being freed contains an active lock that is still in use. This may result in unpredictable behavior by the application including crashes and hangs.

AVRF_SRWLOCK_LOCK_IN_UNLOADED_DLL

This verifier stop is shown if there is an active lock in the DLL being unloaded.
Message: The DLL being unloaded contains an active lock
Param1: Pointer to lock
Param2: Pointer to the name of the DLL being unloaded
Param3: ThreadId of the thread that acquired the lock
Param4: Pointer to the stack trace of the acquire
   This stop may be generated if the DLL being unloaded contains an active lock that is still in use, which may result in unpredictable behavior by the application including crashes and hangs.

Initializing Lock Check

A lock check may be available in Application Verifier. For example, this check may reside in an Application verifier provider DLLand therefore initialized when an application with Application Verifier settings is launched. Steps in initializing this check may involve:
Get the addresses of lock APIs in kernel32
Get the addresses of memory block lookaside function pointers;
If successful in obtaining the addresses of these APIs in kernel32, initialize the storage for tracking locks and set AvrfSrwLockCheckInitialized to TRUE. Otherwise, set it to FALSE;
If AvrfSRWLockCheckInitialized is TRUE;
   Call “InitializeSRWLock” function pointer to initialize SRWLocksList.Lock; and
   Initialize the AVL tree for the locks.
      In one or more implementations, there is not an “un-initialize” for this check.

### Example APIs

The following are examples of APIs may be hooked by the application verifier 118 to perform the verification.
InitializeSRWLock
AcquireSRWLockExclusive
TryAcquireSRWLockExclusive
AcquireReleaseSRWLockExclusive
AcquireSRWLockShared
TryAcquireRWLockShared
ReleaseSRWLockExclusive
ReleaseSRWLockShared
SleepConditionVariableSRW
   The implementation of these hooks is explained in further detail below in respective sections.

AVrfpinitializeSRWLock

This is the hook for InitializeSRWLock and contains the same signature as InitializeSRWLock. The following steps are performed in this hook.

### VOID AvrfpinitializeSRWLock (_out PSRWLOCK SRWLock)

Perform the checks if AvrfSRWLockCheckInitialized is TRUE and process shutdown is not in progress. Otherwise call the original API directly.
   Acquire SRWLocks.Lock with exclusive access to the AVL tree.
   Check the tree to see if the lock being initialized already exists in the tree.
   If it already exists in the tree, this is a re-initialize of the lock.
      Show AVRF_STOP_SRWLOCK_ALREADY_INITIALIZED verifier stop message with a pointer to the last initialization stack trace
   Create and initialize AVRF_SRWLOCK_NODE and insert the node in the AVL tree.
   Release SRWLocks.Lock
   Call the original API InitializeSRWLock.

AVrfpAcquireSRWLockExclusive

This is the hook for AcquireSRWLockExclusive and may contain the same signature as AcquireSRWLockExclusive. The following steps may be performed in this hook.

VOID AvrfpAcquireSRWLockExclusive (_inout PSRWLOCK SRWLock)
Perform the checks if AvrfSRWLockCheckInitialized is TRUE and process shutdown is not in progress. Otherwise call the original API directly.
   Acquire SRWLocks.Lock with exclusive access to the AVL tree.
   If there is no node in the tree for this lock, the lock was not initialized using InitializeSRWLock.
      Is the lock statically initialized? (e.g., is it set to 0)
         If no, show
         AVRF_STOP_SRWLOCK_NOT_INITIALIZED verifier stop.
      Create and initialize the node and insert it in the tree.
   If there is an node, acquire the Owners.Lock for shared access
   Walk the owner list to see if the lock is already acquired by this thread.
   If so, this is a recursive acquire
      Show AVRF_STOP_SRWLOCK_RECURSIVE_ACQUIRE verifier stop message with a pointer to the last acquire stack trace.
   Release the Owners.Lock.
   Release the SRWLocks.Lock
   Call the original API AcquireSRWLockExclusive.
   Create an owner node and initialize the node along with the stack trace if it is not a recursive acquire.
   Acquire Owners.Lock with exclusive access
   ASSERT that the OwnerList is empty.
   Insert the new owner node in the owner list
   Release Owners.Lock

AVrfpAcquireReleaseSRWLockExclusive

This is the hook for AcquireReleaseSRWLockExclusive and may contain the same signature as AcquireReleaseSRWLockExclusive. The following steps may be performed relating to this hook.

BOOLEAN AvrfpAcquireReleaseSRWLockExclusive (_inout PSRWLOCK SRWLock)
Perform the checks if AvrfSRWLockCheckInitialized is TRUE and process shutdown is not in progress. Otherwise call the original API directly.
   Acquire SRWLocks.Lock with exclusive access to the AVL tree.
   If there is no node in the tree for this SRW lock, the lock was not initialized using InitializeSRWLock.
      Is the lock statically initialized? (e.g., is it set to 0)
         If no, show
         AVRF_STOP_SRWLOCK_NOT_INITIALIZED verifier stop.
      Create and initialize the SRW node and insert it in the SRWLocks tree.
   Release the SRWLocks.Lock.
   Call the original API AcquireReleaseSRWLockExclusive

AVrfpTryAcquireSRWLockExclusive

This is the hook for TryAcquireSRWLockExclusive and may contain the same signature as TryAcquireSRWLockExclusive. The following steps may be performed relating to this hook.

BOOLEAN AVrfpTryAcquireSRWLockExclusive (_inout PSRWLOCK SrwLock)
Perform the checks if AvrfSRWLockCheckInitialized is TRUE and process shutdown is not in progress. Otherwise call the original API directly.
   Acquire SrwLocks.Lock with exclusive access to the AVL tree.
   If there is no node in the tree for this lock, the lock was not initialized using InitializeSRWLock.
      Is the lock statically initialized? (e.g., is it set to 0)
         If no, show
         AVRF_STOP_SRWLOCK_NOT_INITIALIZED verifier stop.
      Create and initialize the node and insert it in the tree.
   Release the SrwLocks.Lock.
   Call the original API TryAcquireSRWLockExclusive.
   If the above call returned TRUE
      Create an owner node and initialize the node along with the stack trace.
      Acquire Owners.Lock with exclusive access.
      ASSERT that the Owners.List is empty.
      Insert the new owner node in the Owners.List.
      Release Owners.Lock.
   Return the return value from TryAcquireSRWLockExclusive to the caller.

AVrfpAcquireSRWLockShared

This is the hook for AcquireSRWLockShared and may contain the same signature as AcquireSRWLockShared. The following steps may be performed relating to this hook.

VOID AvrfpAcquireSRWLockShared (_inout PSRWLOCK SRWLock)
Perform the checks if AvrfSRWLockCheckInitialized is TRUE and process shutdown is not in progress. Otherwise call the original API directly.
   Acquire SRWLocks.Lock with exclusive access to the AVL tree.
   If there is not a corresponding node in the tree for this lock, the lock was not initialized using InitializeSRWLock.
      Is the lock statically initialized? (e.g., is it set to 0)
         If no, show
         AVRF_STOP_SRWLOCK_NOT_INITIALIZED verifier stop.
      Create and initialize the node and insert it in the SRWLocks tree.
   If there is a node, acquire the Owners.Lock for shared access
   See if the lock is already acquired by this thread. If so, this is a recursive acquire
      Show AVRF_STOP_SRWLOCK_RECURSIVE_ACQUIRE verifier stop message with a pointer to the last acquire stack trace.
   Release the Owners.Lock.
   Release the SRWLocks.Lock
   Call the original API AcquireSRWLockShared.
   Create an owner node and initialize the node along with the stack trace if this is not a recursive acquire.
   Acquire Owners.Lock with exclusive access
   Insert the new owner node in the owner list
   Release Owners.Lock

AVrfpTryAcquireSRWLockShared

This is the hook for TryAcquireSRWLockShared and may contain the same signature as TryAcquireSRWLockShared. The following steps may be performed relating to this hook.

BOOLEAN AVrfpTryAcquireSRWLockShared (_inout PSRWLOCK SrwLock)
Perform the checks if AvrfSRWLockCheckInitialized is TRUE and process shutdown is not in progress. Otherwise call the original API directly.
   Acquire SRWLocks.Lock with shared access to the AVL tree.
   If there is not a node in the tree that corresponds to this lock, the lock was not initialized using InitializeSRWLock.
      Is the lock statically initialized? (e.g., is it set to 0)
         If no, show
         AVRF_STOP_SRWLOCK_NOT_INITIALIZED verifier stop.
      Create and initialize the node and insert it in the tree.
   Release the SRWLocks.Lock.
   Call the original API TryAcquireSRWLockShared.
   If the above call returned TRUE
      Create an owner node and initialize the node along with the stack trace.
      Acquire Owners.Lock with exclusive access.
      Insert the new owner node in the Owners.List.
      Release Owners.Lock.

AVrfpReleaseSRWLockExclusive

This is the hook for ReleaseSRWLockExclusive and may contain the same signature as ReleaseSRWLockExclusive. The following steps may be performed relating to this hook.

VOID AvrfpReleaseSRWLockExclusive (_inout PSRWLOCK SRWLock)
Perform the checks if AvrfSRWLockCheckInitialized is TRUE and process shutdown is not in progress. Otherwise call the original API directly.
   Acquire SRWLocks.Lock with shared access to the tree.
   If there is no node in the tree for this lock, the lock was not initialized.
      Show AVRF_STOP_SRWLOCK_NOT_INITIALIZED verifier stop message saying that the lock was not initialized.
   If there is a node, acquire the Owners.Lock for shared access
   See if there is an owner node for this thread. If there is no owner node for this thread,
      Show AVRF_STOP_SRWLOCK_INVALID_OWNER verifier stop message saying that invalid owner releasing the lock.
   See if the lock is acquired for exclusive access by this thread. If not, this is a mismatched release.
      Show
      AVRF_STOP_SRWLOCK_MISMATCHED_ACQUIRE_RELEASE verifier stop message with a pointer to the last release stack trace.
   Release the Owners.Lock.
   Release the SRWLocks.Lock.
   Call the original API ReleaseSRWLockExclusive.
   Acquire Owner.Lock with exclusive access if there is an owner node.
   Delete the owner node from the owner list
   Release Owners.Lock

AVrfpReleaseSRWLockShared

This is the hook for ReleaseSRWLockShared and may contain the same signature as ReleaseSRWLockShared. The following steps may be performed in relation to this hook.

VOID AvrfpReleaseSRWLockShared (_inout PSRWLOCK SRWLock)
Perform the checks if AvrfSRWLockCheckInitialized is TRUE and process shutdown is not in progress. Otherwise call the original API directly.
   Acquire SRWLocks.Lock with shared access to the tree.
   If there is no node in the tree for this SRW lock, the lock was not initialized.
      Show AVRF_STOP_SRWLOCK_NOT_INITIALIZED verifier stop message saying that the lock was not initialized.
   If there is a node, acquire the Owners.Lock for shared access
   See if there is an owner node for this thread. If there is no owner node for this thread,
      Show AVRF_STOP_SRWLOCK_INVALID_OWNER verifier stop message saying that invalid owner releasing the lock.
   See if the lock is acquired for shared access by this thread. If not, this is a mismatched release.
      Show
      AVRF_STOP_SRWLOCK_MISMATCHED_ACQUIRE_RELE ASE verifier stop message with a pointer to the last release stack trace.
   Release the Owners.Lock.
   Release the SRWLocks.Lock.
   Call the original API ReleaseSRWLockShared.
   Acquire Owners.Lock with exclusive access if there is an owner node
   Delete the owner node from the owner list
   Release Owners.Lock

AVrfpSleepConditionVariableSRW

This is the hook for SleepConditionVariableSRW.

Memory Free Callback

This API may involve a search of an SRWLocks.List to see if the memory being freed belongs to a lock and display a verifier stop if the lock is active. The following steps may be performed in relation to this hook.
Perform the checks if AvrfSRWLockCheckInitialized is TRUE and process shutdown is not in progress.
   Acquire SRWLocks.Lock with exclusive access to the tree.
   Acquire the Owners.Lock in shared mode.
   If there is an lock in the memory range that is being freed, check the Owners.List to see if the list is empty.
   Release the Owners.Lock.
   Remove the node from the SRWLocks.List.
   Release the SRWLocks.lock.
   If the Owners.List is not empty
      Display AVRF_STOP_SRWLOCK_IN_FREED_MEMORY verifier stop message with the thread id and acquire stack trace saying that the memory being freed contains a lock that is active.
   Free the node.

DLL Unload Callback

This API may involve a search of a SRWLocks.List to see if a lock falls in the DLL address range and display a verifier stop if the lock is active.
Perform the checks if AvrfSRWLockCheckInitialized is TRUE and process shutdown is not in progress.
   Acquire SRWLocks.Lock with exclusive access to the tree.
   Acquire the Owners.Lock in shared mode.
   If there is an lock in the DLL address range, check the Owners.List to see if the list is empty.
   Release the Owners.Lock.
   Remove the node from the SRWLocks.List.
   Release the SRWLocks.lock.
   If the OwnerList is not empty
      Display AVRF_STOP_SRWLOCK_IN_UNLOADED_DLL verifier stop message with the thread id and acquire stack trace saying that the DLL being unloaded contains a lock that is active.
   Free the node.

Thread Exit/Termination

This API may involve a search of an Owners.List of each lock in the SRWLock.List to see if the exiting thread or the thread being terminated has an active lock and display a verifier stop if it does.
Perform the checks if AvrfSRWLockCheckInitialized is TRUE and process shutdown is not in progress.
   Acquire SRWLocks.Lock with shared access to the tree.
   For each node,
      acquire the Owners.Lock in shared mode.
      If the owner list contains an entry for this thread,
         Show
         AVRF_STOP_SRWLOCK_EXIT_THREAD_OWNS_LOCK verifier stop message with the thread id and acquire stack trace saying that the thread being terminated or exiting owns an active lock.
      Release the Owners.Lock.
   Release the SRWLocks.lock.

### Example Procedures

The following discussion describes shared resource access verification techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

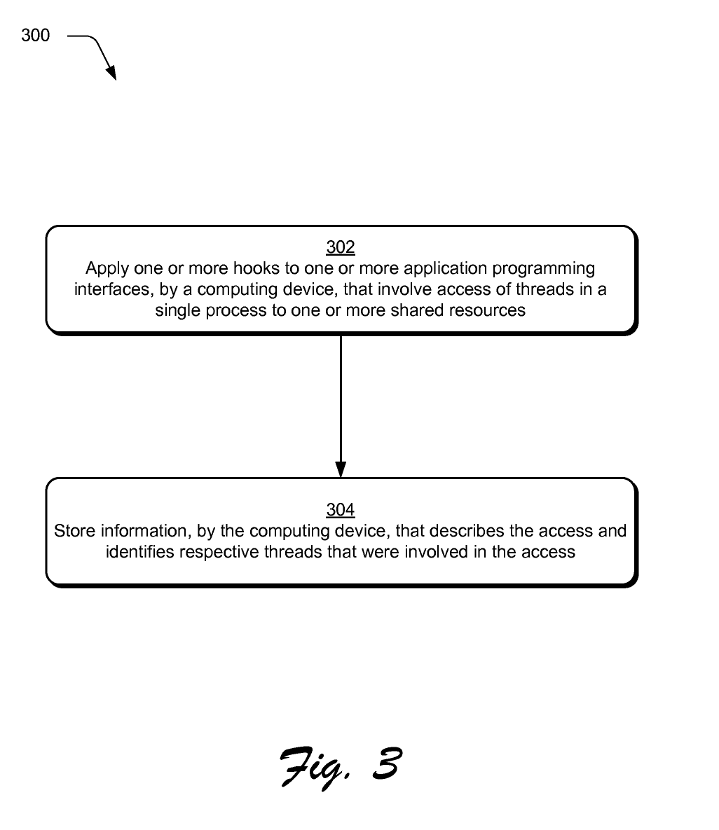

FIG. 3 depicts a procedure 300 in an example implementation in which information is stored that identifies ownership of a lock used to manage access to a resource by threads in a process that are executed by a computing device. One or more hooks are applied to one or more application programming interfaces, by a computing device, that involve access of threads in a single process to one or more shared resources (block 302). The application verifier 118, for instance, may hook various API's and update import address table (IAT) entries of binaries being tested at runtime. This check may be implemented as part of a slim reader/writer (SRW) lock check that may be implemented as part of verifier.dll an inbox component that ships with an operating system (e.g., Windows, which is a trademark of Microsoft Corp., Redmond, Wash.) as well as vfbasics.dll, which is an out of band verifier provider.

The application verifier may be loaded early on in a loading process for the application being tested. The application verifier 118, once loaded, may then check the IAT entries of other binaries being loaded. If the application verifier 118 has a hook (i.e., replacement API) for these entries, the entry is replaced with the hook and the address of the original API is saved in a hooking table of the application verifier. Accordingly, when a dynamic link library (DLL) calls one of the APIs that is hooked, it essentially calls the hook because of the IAT patching just described.

Information is stored, by the computing devices, that describes the access and identifies respective threads that were involved in the access (block 304). Continuing with the previous example, hooks employed by the application verifier 118 may be used capture the information that describes interaction performed via the hooked API, such as to identify ownership of locks involved in the access. In this way, the application verifier 118 may support diagnostic techniques that may be used to address errors that may be encountered. A variety of different information may be captured and stored, further discussion of which may be found in relation to the following figure.

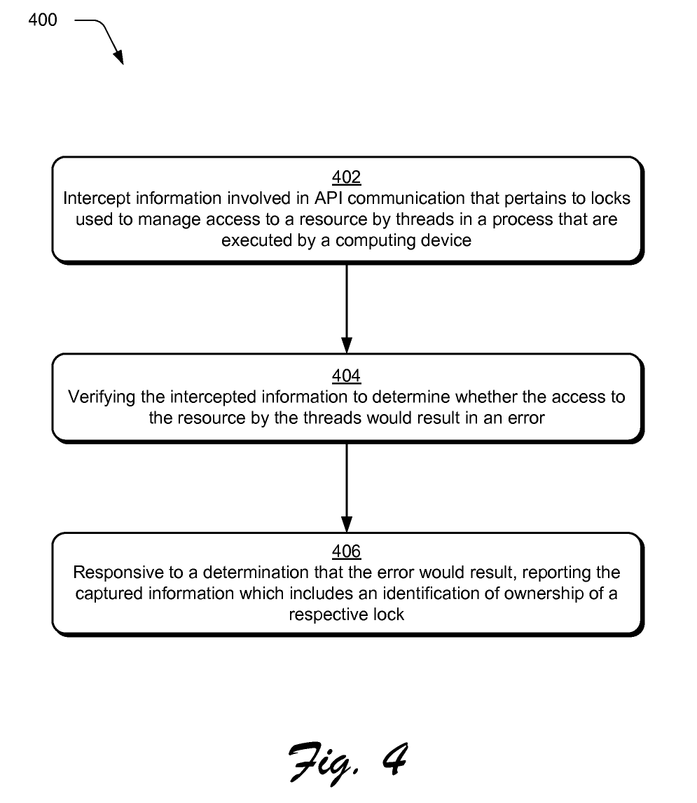

FIG. 4 depicts a procedure 400 in an example implementation in which verification techniques are employed on data that pertains to locks used to manage access to a resource by threads in a process. Information is captured that is involved in API communication that pertains to locks used to manage access to a resource by threads in a process that are executed by a computing device (block 402).

The application verifier 118, for instance, may hook APIs for finding issues with the usage of locks by the reader/writer module 112. The lock APIs in the import address table (IAT) of the binaries, for instance, may be replaced with application verifier hooks. Therefore, if a module loaded by an application calls a lock API of the reader/writer module 112, the application verifier hook is called instead. In this way, the application verifier 118 may track these calls and intercept desired information. A variety of different information may be intercepted, such as an address of the lock, whether stack memory or heap memory is involved, identification of a current owner of the lock, whether the lock is being acquired for shared or exclusive access, involvement of stack traces, and so on.

The intercepted information is verified to determine whether the access to the resource by the threads would result in an error (block 404). The application verifier 118, for instance, may analyze both data involved in a call to an API as well as callback data received from the API. This data may be analyzed using a variety of techniques as described above for the verifier stops. Therefore, responsive to a determination that the error would result, the captured information is reported which includes an identification of ownership of a respective lock (block 406), such as to a debugger 208 or reporting service 212. The application verifier 118 may perform the validations before forwarding the information to the original API that was called and report an error when validations fail. If valid, the information may be reported to the original API.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
applying one or more hooks to one or more application programming interfaces (APIs), by a computing device, that involve access of threads in a single process to one or more shared resources; and
storing information, by the computing device, that describes the access and identifies respective said threads that were involved in the access.

2. A method as described in claim 1, wherein the applying of the one or more hooks includes replacing import address table (IAT) entries of the one or more application programming interfaces and saving the replaced import address table (IAT) in a hooking table.

3. A method as described in claim 1, further comprising:
capturing data via the one or more hooks;
performing one or more verifications using the data; and
responsive to a determination that the data is verified, calling a respective said application programming interface.

4. A method as described in claim 3, wherein the storing is performed responsive to a determination that the data in the verification would result in an error.

5. A method as described in claim 3, wherein at least one said verification relates to use of an uninitialized lock.

6. A method as described in claim 3, wherein at least one said verification relates to reinitializing a lock of a reader/writer module that is configured to manage access to the one or more shared resources.

7. A method as described in claim 3, wherein at least one said verification relates to a mismatched acquire and release.

8. A method as described in claim 3, wherein at least one said verification relates to exit or termination of a respective said thread while holding a lock of a reader/writer module that is configured to manage access to the one or more shared resources.

9. A method as described in claim 3, wherein at least one said verification relates to release of a lock of a reader/writer module, which is configured to manage access to the one or more shared resources, that is not owned by a respective said thread that initiated the release.

10. A method as described in claim 3, wherein at least one said verification relates to an attempt to free memory associated with an active lock of a reader/writer module that is configured to manage access to the one or more shared resources.

11. A method as described in claim 1, further comprising reporting the information to a debugger associated with an application that corresponds to the one or more application programming interfaces responsive to detection of an issue.

12. A method as described in claim 1, further comprising reporting the information for receipt by a network service responsive to detection of an issue.

13. A method comprising:
intercepting information involved in an application programming interface (API) communication that pertains to locks used to manage access to a resource by threads in a process that are executed by a computing device;
verifying the intercepted information to determine whether the access to the resource by the threads would result in an error; and
responsive to a determination that the error would result, reporting the captured information which includes an identification of ownership of a respective said lock.

14. A method as described in claim 13, wherein the API communication involves intercepting a call to the API.

15. A method as described in claim 13, wherein the API communication involves intercepting callback information from the API.

16. A method as described in claim 13, wherein the verifying involves:
use of an uninitialized lock;
reinitializing a lock of a reader/writer module that is configured to manage access to the one or more shared resources;
a mismatched acquire and release;
exit or termination of a respective said thread while holding a lock of the reader/writer module;
release of a lock of the reader/writer module; or
an attempt to free memory associated with an active lock of the reader/writer module.

17. A method comprising:
intercepting a call via a hook to an API of a reader/writer module, executed by a computing device, that is configured to manage access of threads in a single process to one or more shared resources of the computing device;
capturing information, related to the call, that describes an address of a lock of the reader/writer module involved and current ownership of the lock;
forwarding the call to the API responsive to a verification that the call would not result in an error; and
reporting the captured information responsive to a verification that the call would result in an error;

18. A method as described in claim 17, wherein the capturing information further comprises information describing whether the address is on stack memory or heap memory and information describing and information describing stack traces

19. A method as described in claim 17, wherein the information further describes whether the lock is acquired for shared or exclusive access.

20. A method as described in claim 17, wherein the verification involves:
use of an uninitialized lock;
reinitializing a lock of a reader/writer module that is configured to manage access to the one or more shared resources;
a mismatched acquire and release;
exit or termination of a respective said thread while holding a lock of the reader/writer module;
release of a lock of the reader/writer module; or
an attempt to free memory associated with an active lock of the reader/writer module.
